(19) United States
(12) Patent Application Publication
(10) Pub. No.: US 2007/0193379 A1
(43) Pub. Date: Aug. 23, 2007

(54) Electronic Scale for Measuring Gas in Pressurized Cylinders Over a Wide Range of Capacities

(76) Inventor: William P. McCluskey, Austin, TX (US)

Correspondence Address: FISH & RICHARDSON P.C., P.O BOX 1022, Minneapolis, MN, 55440-1022, US

(21) Appl. No.: 11/548,645

(22) Filed: Oct. 11, 2006

Related U.S. Application Data
(60) Provisional application No. 60/775,609, filed on Feb. 21, 2006.
(60) Provisional application No. 60/819,837, filed on Jul. 11, 2006.

(51) Int. Cl. G01N 5/04; G01M 19/00

(52) U.S. Cl. 73/865.9

(57) ABSTRACT

A scale for calculating a remaining time that gas remains in a cylinder. An electronic scale calculates an actual tare weight of the gas in the cylinder using the total weight of the cylinder with the gas and the weight of the cylinder when empty. The remaining time that gas remains in the cylinder is calculated by the scale using the flow rate of the gas and the actual tare weight of gas in the cylinder. Further, the scale may calculate a percentage of the gas remaining in the cylinder using the actual tare weight of the gas in the cylinder and the maximum tare weight of the gas for the cylinder. By estimating the remaining time that gas remains in the cylinder in this manner, the scale is able to measure gas in pressurized cylinders over a wide range of capacities.

### CROSS REFERENCE TO RELATED APPLICATIONS

This application is related to the following commonly owned co-pending U.S. patent applications:

Provisional Application Ser. No. 60/775,609, “Hand Held Electronic Scale, ” filed Feb. 21, 2006, and claims the benefit of its earlier filing date under 35 U.S.C. §119(e); and

Provisional Application Ser. No. 60/819,837, “Electronic Scale For Weighing Gas,” filed Jul. 11, 2006, and claims the benefit of its earlier filing date under 35 U.S.C. §119(e).

### TECHNICAL FIELD

The present invention relates to the field of measuring the contents of containers, such as propane cylinders, and more particularly to an electronic scale that estimates the remaining time that gas may last in a wide range of propane cylinders (e.g., cylinders with capacities that range from 4.25 to 60 pounds of propane).

### BACKGROUND

Currently, refillable propane cylinders are being marketed as designed to hold a recommended maximum tare weight of propane of 4.25, 5, 10, 11, 14, 20, 30, 40, 43.5 50 and 60 pounds. Tare weight refers to the weight of a container with a substance net of the empty weight of the container, such as a cylinder holding propane gas. These cylinders may be used for gas grills, outdoor mosquito control devices, portable heaters, fish fryers, turkey fryers, brush burners, fork lifts, propane powered generators, portable horse washers, camp stoves and patio heaters to name a few.

There is a need to be able to accurately gauge the amount of gas remaining in a cylinder as well as the remaining time that gas remains in the cylinder so that the cylinder is not refilled before necessary. Users have attempted to estimate the amount of gas remaining in the cylinder and therefore estimate the remaining time that gas remains in the cylinder using various devices, such as pressure gauges, exterior cylinder magnetic strips, and mechanical scales attached to gas grills. None of these devices accurately gauge the amount of gas remaining in a cylinder for a wide range of cylinders (e.g., 4.25, 5, 10, 11, 14, 20, 30, 40, 43.5, 50 and 60 pounds) as well as accurately estimate the remaining time that gas remains in the cylinder as discussed below.

A pressure gauge may be used to measure the reduced or increased pressures in a cylinder, such as a propane cylinder. One type of pressure gauge may be connected between the propane cylinder and a device, such as a regulator, on a gas grill. The operating instructions to use this pressure gauge inform the user to use the propane for at least five minutes before checking for low gas levels. The operating instructions further state that in extremely cod weather, the propane in the cylinder may not vaporize as rapidly as needed, and, consequently, the gauge will read the cylinder as having low gas when it does not. The operating instructions further state that water can condense under the gauge dial thereby making it difficult to read the gauge. Another type of pressure gauge currently being marketed uses a movable screen that includes a reading for a hot day, a cool day and a cold day thereby recognizing that the gas pressure in a cylinder can be different depending on the temperature where the cylinder resides. These pressure gauges are not designed to measure the exact amount of gas in a cylinder; rather, they are intended to measure the pressure in a cylinder and show the level of pressure. Users may attempt to derive an estimate of the remaining amount of gas in the cylinder based on the measured pressure. However, the measure of the remaining pressure can be influenced by the temperature and therefore not provide an accurate reading. As a result, the estimate of the remaining gas in the cylinder may be inaccurate.

Alternatively, users may use magnetic strips in an attempt to estimate the remaining gas level in the cylinder. These magnetic strips may be designed to attach to the outside of a propane cylinder near the bottom of the cylinder and out of direct sunlight. Typically, the propane needs to be turned on for two to five minutes before the magnetic strip attempts to measure the level of gas remaining in the container. If the gas level is within the range of the magnetic strip, the magnetic strip is designed to illustrate bars that shift indicating the level of gas in the cylinder. However, it is not easy to interpret the bars on the magnetic strip and deduce a level of propane remaining in the cylinder. Further, the bars have to be interpreted differently depending on the size of the cylinder. For example, for a 4.25 pound propane cylinder, the bar could be interpreted as one level; whereas, the exact same bar could be interpreted as another level for a 40 pound propane cylinder since the bottom part of the 40 pound cylinder represents a larger difference in percentage of total maximum propane in comparison to the 4.25 pound cylinder.

Alternatively, the user may use a mechanical scale attached to a gas grill to estimate the remaining gas level in the cylinder. U.S. Pat. No. 4,245,505 teaches a mechanical scale that is designed to mount to the bottom of a gas grill with a default weight of an empty cylinder of 18 pounds. U.S. Pat. No. 4,524,617 teaches a similar mechanical scale with a default weight of an empty cylinder of 18.5 pounds. Both of these scales can be physically adjusted to approximate the weight of the cylinder by placing the empty cylinder on the scale and turning a screw until the scale registers at a recommended point. The scale of U.S. Pat. No. 4,524,617 allows for an approximate adjustment of 1.5. pounds but this total adjusted cylinder weight of 20 pounds would not cover a cylinder that weighs 21 pounds or more. Further, U.S. Pat. No. 6,148,668 teaches a similar mechanical scale with a default weight of a cylinder using a standard-sized portable fuel tank. These scales are generally designed for use with a 20 pound propane cylinder and all either mount to a gas grill and/or they are secured to the cylinder. Neither of these scales are designed to gauge the propane in a wide variety of cylinders with capacities that range from 4.25 to 60 pounds of propane. Further, many cylinders that are being weighed are replacements. Typically, the user takes the empty cylinder to the store and replaces the empty cylinder with a full cylinder. The empty cylinder is not returned to the buyer. This replacement cylinder may have a different empty weight than the one that was exchanged and if that is the case, there will be an error in the indicated weight of the propane on the scale since the scale was adjusted to the empty weight of the cylinder which is not the one being used.

Therefore, there is a need in the art for an improved scale for measuring gas in pressurized cylinders that have a wide range of capacities.

### SUMMARY

The problems outlined above may at least in part be solved in some embodiments by the electronic scale calculating an actual tare weight of the gas in the cylinder using the total weight of the cylinder with the gas and the weight of the cylinder when empty. The remaining time that gas remains in the cylinder may be calculated by the electronic scale using the flow rate of the gas and the actual tare weight of the gas in the cylinder. The flow rate of the gas may either be inputted to the electronic scale by a user or calculated by the electronic scale by estimating the change in tare weight of the gas over time. By estimating the remaining time that gas remains in the cylinder in this manner, the electronic scale is able to measure gas in pressurized cylinders over a wide range of capacities (e.g., cylinders with capacities that range from 4.25 to 60 pounds of propane). Further, the electronic scale does not require that propane be turned on for 2 to 5 minutes to measure the level of propane unless the flow rate is to be calculated by the timer. Additionally, the electronic scale can be used in all weather conditions, including being used in direct sunlight.

In one embodiment of the present invention, a method for calculating a remaining time that gas remains in a cylinder comprising the step of receiving a weight of the cylinder when empty. The method further comprises calculating a total weight of the cylinder with the gas. The method further comprises calculating an actual tare weight of the gas in the cylinder using the total weight of the cylinder with the gas and the weight of the cylinder when empty. The method further comprises calculating the remaining time the gas remains in the cylinder using a flow rate of the gas and the actual tare weight of the gas in the cylinder.

The foregoing has outlined rather generally the features and technical advantages of one or more embodiments of the present invention in order that the detailed description of the invention that follows may be better understood. Additional features and advantages of the invention will be described hereinafter which may form the subject of the claims of the invention.

The details of one or more embodiments of the invention are set forth in the accompanying drawings and the description below. Other features, objects, and advantages of the invention will be apparent from the description and drawings, and from the claims.

### DESCRIPTION OF DRAWINGS

A better understanding of the present invention can be obtained when the following detailed description is considered in conjunction with the following drawings, in which:

FIG. 1 illustrates an electronic scale that is a suspension-type scale configured in accordance with an embodiment of the present invention;

FIG. 2 illustrates a data processing system embodied in the main or remote housing of the electronic scale in accordance with an embodiment of the present invention;

FIG. 3 illustrates an electronic scale that is a platform-based scale configured in accordance with an embodiment of the present invention; and

FIG. 4 is a flowchart of a method for calculating a remaining time that gas remains in a cylinder in accordance with an embodiment of the present invention.

### DETAILED DESCRIPTION

Even though the following discusses the present invention in connection with propane cylinders, the principles of the present invention may be applied to cylinders holding other types of gasses. A person of ordinary skill in the art would be capable of applying the principles of the present invention to cylinders holding other types of gasses. Further, embodiments covering such cylinders holding other types of gasses would fall within the scope of the present invention.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

The present invention discloses an electronic scale used to measure the remaining gas, such as butane and propane, in a pressurized cylinder. The electronic scale may calculate the tare weight of the gas and then use this tare weight to calculate the remaining percentage of gas compared to a full cylinder. The scale may further receive or calculate the flow rate of the gas. The scale may use the flow rate of the gas to calculate a remaining time the gas will last until it reaches a predetermined level and the cylinder needs to refilled or exchanged. It is believed that the percentage of remaining gas in a cylinder and the estimated remaining time the gas will last is a more useful indication of the amount of gas in a pressurized cylinder than just weight or pressure.

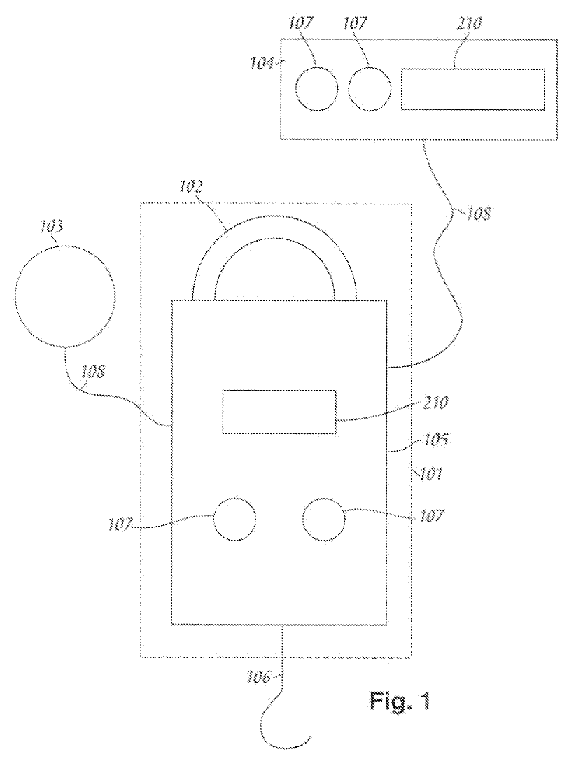

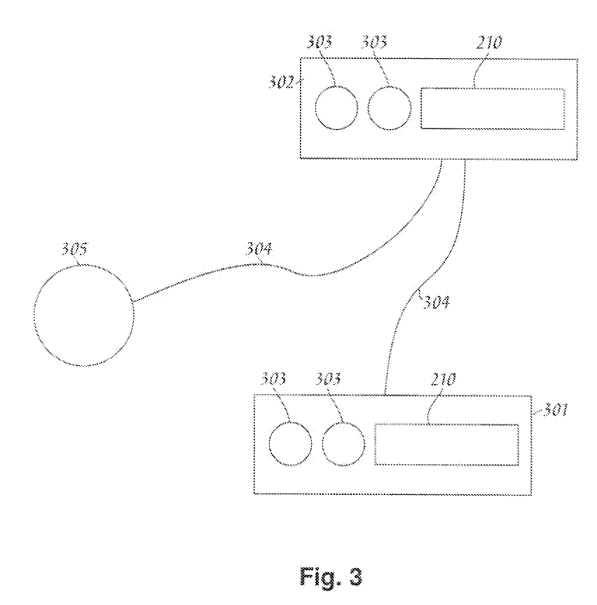

The scale may be a suspension unit or a platform based unit as illustrated in FIGS. 1 and 3, respectively. Referring to FIG. 1, FIG. 1 illustrates an electronic scale 100 as a suspension unit used to measure the remaining gas, such as butane and propane, in a pressurized cylinder. Electronic scale 100 may include a suspension unit 101 as illustrated with the dashed lines. Suspension unit 101 includes a handle 102. Handle 102 may be used by a user to hold electronic scale 100 by the hand or mounting scale 100 to a wall or bracket or to the bottom of a gas grill. In one embodiment, suspension unit 101 includes a flow meter 103 or a remote housing 104. In another embodiment, suspension unit 101 does not include flow meter 103 or remote housing 104. Further, suspension unit 101 in an alternative embodiment has an alternative mounting bracket to handle 102.

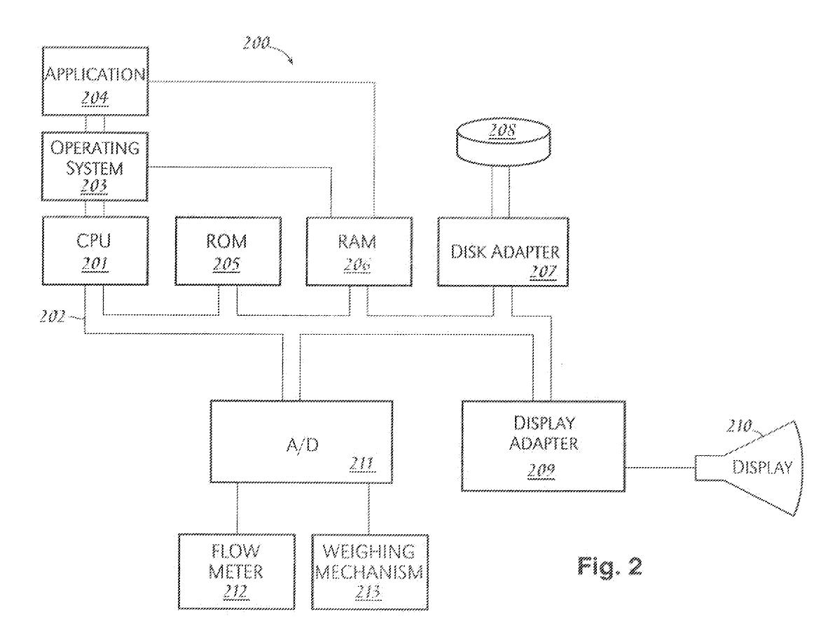

Referring to FIG. 1, scale 100 may include a molded or metal main housing 105 connected to a hook 106 or clasp or some other device capable of attaching suspension unit 101 to an empty cylinder or to a cylinder with gas and attached gauges and regulator, if any, so that the cylinder can be suspended off the ground and weighed. Main housing 105 or remote housing 104 (if needed) may enclose a data processing system 200 as illustrated in FIG. 2.

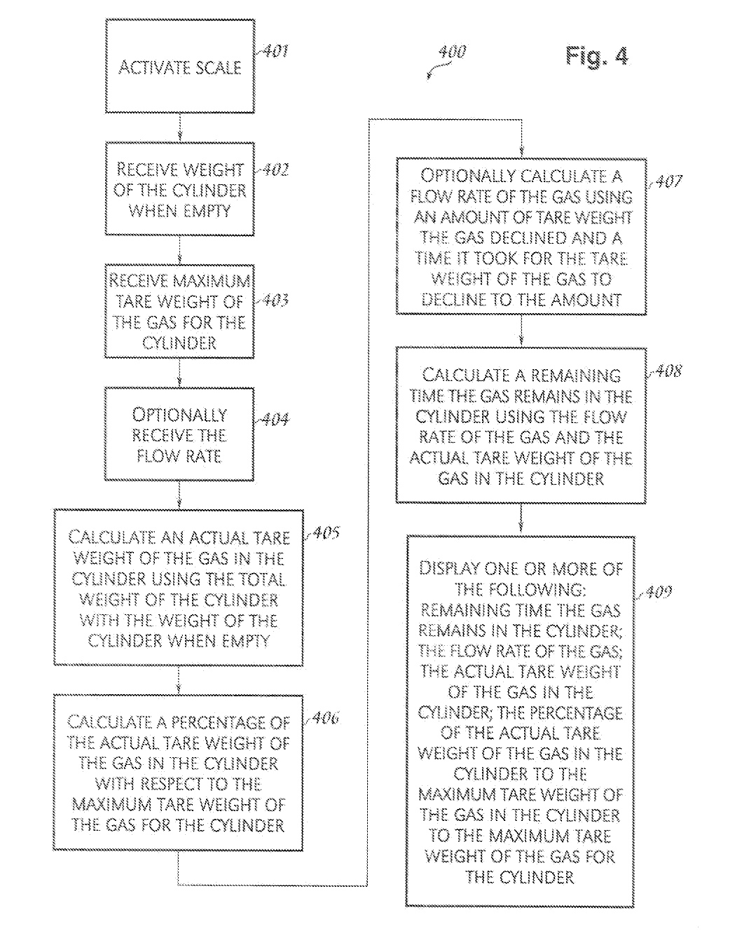

Referring to FIG. 2, FIG. 2 illustrates a data processing system 200 configured in accordance with an embodiment of the present invention. Data processing system 200 may include a processor 201 coupled to various other components by system bus 202. An operating systems 203 may run on processor 201 and provide control and coordinate the functions of the various components of FIG. 2. An application 204 in accordance with the principles of the present invention may run in conjunction with operating system 203 and provide calls to operating system 203 where the calls implement the various functions or services to be performed by application 204. Application 204 may include, for example, an application for calculating a remaining time that gas remains in a pressurized cylinder as described below in association with FIG. 4.

Referring to FIG. 2, Read-Only Memory (ROM) 205 may be coupled to system bus 202 and include a basic input/output system (“BIOS”) that controls certain basic functions of system 200. Random Access Memory (RAM) 206 and disk adapter 207 may also be coupled to system bus 202. It should be noted that software components including operating system 203 and application 204 may be loaded into RAM 206 which may be system's 200 main memory for execution. Disk adapter 207 may be an integrated drive electronics (“IDE”) adapter that communicates with a disk unit 208, e.g., disk drive. It is noted that the application for calculating a remaining time that gas remains in a pressurized cylinder may reside in either disk unit 208 or in application 204.

Referring to FIG. 2, system 200 may further include a display adapter 209 connected to a display 210 configured to display the required inputs, stored weights and calculations as discussed further below. System 200 may further include an analog/digital converter 211 for converting analog signals into digital signals. These analog signals may originate from a flow meter 212 (flow meter 212 is equivalent to flow meter 103 and flow meter 305) and a weighing mechanism 213.

Implementations of the invention include implementations as a computer system programmed to execute the method or methods described herein, and as a computer program product. According to the computer system implementations, sets of instructions for executing the method or methods may be resident in the random access memory 205 of one or more computer systems configured generally as described above. Until required by system 200, the set of instructions may be stored as a computer program product in another computer memory, for example, in disk unit 208. One skilled in the art would appreciate that the physical storage of the sets of instructions physically changes the medium upon which it is stored so that the medium carries computer readable information. The change may be electrical, magnetic, chemical or some other physical change.

It is noted that system 200 of FIG. 2 may include other components not depicted and that FIG. 2 is illustrative. It is further noted that embodiments of the present invention are not to be limited in scope to the embodiment depicted in FIG. 2.

Returning to FIG. 1, scale 100 may further include buttons 107 or switches or electronic controls or other similar means to turn on scale 100 and for inputting the required weights and flow rate. Scale 100 may include a wire 108 or cable that attaches main housing 105 to flow meter 103 and to remote housing 104. Alternatively, these items could communicate with each other by radio waves which could eliminate the need for wire 108 or cables. In one embodiment, flow meter 103 and attached wire 108 or cable may not be needed if the flow rate of the gas was to be calculated by using a programmed list of devices the cylinder is to be used with as discussed further below. Further, flow meter 103 and attached wire 108 or cable may not be needed if the flow rate of the gas was to be calculated by the change in the tare weight of the gas over time. Scale 100 may store the inputted and calculated weights, flow rate, remaining percentage and remaining time of the gas in memory 205 (FIG. 2). Scale 100 is configured to calculate and display the tare weight of the gas in pounds or kilograms and display the percent of the remaining gas as discussed below in connection with FIG. 4. Scale 100 is further configured to calculate the flow rate of the gas and the estimated time the remaining gas in the pressurized cylinder will last as discussed further below in connection with FIG. 4.

Scale 100 may further include a display 210 (FIGS. 1 and 2) for displaying the required inputs, stored weights and calculations as discussed further below.

It is noted that scale 100 of FIG. 1 may include other components not depicted and that FIG. 1 is illustrative. It is further noted that embodiments of the present invention are not to be limited in scope to the embodiment depicted in FIG. 1.

As discussed above, the scale may be a suspension unit or a platform based unit. FIG. 3 illustrates an electronic scale 300 that is platform based in accordance with an embodiment of the present invention. Referring to FIG. 3, electronic scale 300 is configured similarly as electronic scale 100 (FIG. 1). The differences are discussed below.

Electronic scale 300 includes a weighing base 301 that may be constructed of a molded or a metal housing capable of weighing either an empty cylinder or a cylinder with gas with attached gauges and a regulator, if any. Weighing base 301 may be configured to house weighing mechanism 213 (FIG. 2). In one embodiment, weighing base 301 may be placed on the ground or the bottom of a gas grill or other device and cylinder is placed on top of weighing base 301. Weighing base 301 or remote housing 302 (if needed) may enclose data processing system 200 as discussed above in connection with FIG. 2.

Weighing base 301 and remote housing 302 may have a display 210 (FIG. 2) or similar device for viewing the required input, stored weights and calculations. Weighing base 301 and remote housing 302 may have one or more buttons 303 or switches or electronic controls or other similar means to turn on scale 300 and for inputting the required weights and flow rate. Scale 300 may include a wire 304 or cables that attach weighing base 301 to a flow meter 305 and to remote housing 302. Alternatively, these items could communicate with each other by radio waves which could eliminate the need for wire 304 or cables. In one embodiment, flow meter 305 and attached wire 304 or cable may not be needed if the flow rate of the gas was to be calculated by using a programmed list of devices the cylinder is to be used with. Further, flow meter 305 and attached wire 304 or cable may not be needed if the flow rate of the gas was to be calculated by the change in the tare weight of the gas over time. Scale 300 may store the inputted and calculated weights, flow rate, remaining percentage and remaining time of the gas in memory 205 (FIG. 2). Scale 300 is configured to calculate and display the tare weight of the gas in pounds or kilograms and display the percent of the remaining gas as discussed below in connection with FIG. 4.

It is noted that scale 300 of FIG. 3 may include other components not depicted and that FIG. 3 is illustrative. It is further noted that embodiments of the present invention are not to be limited in scope to the embodiment depicted in FIG. 3.

Referring to FIG. 4, FIG. 4 illustrates a flowchart of a method 400 for calculating a remaining time that gas remains in pressurized cylinder in accordance with an embodiment of the present invention.

Referring to FIG. 4, in connection with FIGS. 1-3, in step 401, a user activates scale 100/scale 300.

In step 402, scale 100/scale 300 receives the weight of the cylinder when empty. In one embodiment, the user of scale 100/scale 300 inputs the weight of the cylinder when empty to scale 100/scale 300.

In step 403, scale 100/scale 300 receives a maximum tare weight of the gas for the cylinder. In one embodiment, the user of scale 100/scale 300 inputs the maximum tare weight of the gas for the cylinder to scale 100/scale 300.

In step 404, scale 100/scale 300 optionally receives the flow rate. In one embodiment, scale 100 receives the flow rate from flow meter 103. In one embodiment, scale receives the flow rate from flow meter 305. If scale 100/scale 300 does not receive the flow rate in step 404, then scale 100/scale 300 computes the flow rate as discussed further below in connection with step 407.

In step 405, scale 100/scale 300 calculates an actual tare weight of the gas in the cylinder using the total weight of the cylinder with the gas and the weight of the cylinder when empty. In one embodiment, the actual tare weight of the gas in the cylinder is equal to the total weight of the cylinder with the gas minus the weight of the cylinder when empty.

In step 406, scale 100/scale 300 calculates a percentage of the actual tare weight of the gas in the cylinder with respect to the maximum tare weight of the gas for the cylinder. Scale 100/scale 300 may then be able to indicate the percentage of gas remaining in the cylinder in addition to or in lieu of indicating the amount of time that gas remains in the cylinder. The percentage of the actual tare weight of the gas in the cylinder with respect to the maximum tare weight of the gas for the cylinder is equal to the actual gas tare weight divided by the maximum tare weight of the gas for the cylinder.

In step 407, scale 100/scale 300 optionally calculates a flow rate of the gas using an amount of the tare weight of the gas declined and a time it took for the tare weight of the gas to decline that amount. That is, the flow rate could be estimated by calculating the change in tare weight of the gas over time. For example, system 200 may include a timer (hardware or software) that activates when scale 100/scale 300 is activated. If the gas tare weight dropped one tenth of a pound in five minutes, then the flow rate would be 1.2. pounds per hour. In another embodiment, the flow rate of the gas may be calculated by scale 100/scale 300 selecting from a programmed list of devices the cylinder containing the gas to be measured. For example, scale 100/scale 300 may be programmed to contain an estimated propane flow rate for large gas grills, medium sized gas grills, small gas grills, portable gas grills, patio heaters, portable heaters, mosquito control devices, fish fryers and other devices that use propane. For instant, a cylinder with 20 pounds of propane may contain about 430,000 BTUs (British Thermal Units) which would allow a mosquito control device to operate for about 21 days. However, that same amount of propane would run out much faster in a large gas grill or fish fryer that was burning at maximum output. Step 407 is optionally executed by scale 100/scale 300 if scale 100/scale 300 does not receive the flow rate in step 404.

In step 408, scale 100/scale 300 calculates the remaining time the gas remains in the cylinder using the flow rate of the gas and the actual tare weight of the gas in the cylinder. In one embodiment, the remaining time the gas remains in the cylinder is calculated by the actual tare weight of the gas in the cylinder divided by the flow rate of the gas.

In step 409, scale 100/scale 300 displays one or more of the following: remaining time the gas remains in the cylinder; the flow rate of the gas; the actual tare weight of the gas in the cylinder; the percentage of the actual tare weight of the gas in the cylinder with respect to maximum tare weight of the gas for the cylinder.

Method 400 may include other and/or additional steps that, for clarity, are not depicted. Method 400 may be executed in a different order presented and the order presented in the discussion of FIG. 4 is illustrative. Certain steps in method 400 may be executed in a substantially simultaneous manner or may be omitted.

Although the method, computer program product and system are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims.

A number of embodiments of the invention have been described. Nevertheless, it will be understood that various modifications may be made without departing from the spirit and scope of the invention. Accordingly, other embodiments are within the scope of the following claims.

What is claimed is:

1. A method for calculating a remaining time that gas remains in a cylinder, the method comprising the steps of:
receiving a weight of said cylinder when empty;
calculating a total weight of said cylinder with said gas;
calculating an actual tare weight of said gas in said cylinder using said total weight of said cylinder with said gas and said weight of said cylinder when empty; and
calculating said remaining time said gas remains in said cylinder using a flow rate of said gas and said actual tare weight of said gas in said cylinder.

2. The method as recited in claim 1, wherein said actual tare weight of said gas in said cylinder is equal to said total weight of said cylinder with said gas minus said weight of said cylinder when empty.

3. The method as recited in claim 1 further comprising the step of:
receiving said flow rate of said gas.

4. The method as recited in claim 1 further comprises the step of:
receiving said flow rate of said gas from a flow meter.

5. The method as recited in claim 1 further comprising the step of:
calculating said flow rate of said gas using an amount of tare weight said gas declined and a time it took for said tare weight of said gas to decline to said amount.

6. The method as recited in claim 1, wherein said remaining time said gas remains in said cylinder is calculated by said actual tare weight of said gas in said cylinder divided by said flow rate of said gas.

7. The method as recited in claim 1 further comprising the step of:
receiving a maximum tare weight of said gas for said cylinder; and
calculating a percentage of said actual tare weight of said gas in said cylinder to said maximum tare weight of said gas for said cylinder.

8. The method as recited in claim 7 further comprising the steps of:
displaying said remaining time said gas remains in said cylinder;
displaying said flow rate of said gas;
displaying said actual tare weight of said gas in said cylinder; and
displaying said percentage of said actual tare weight of said gas in said cylinder to said maximum tare weight of said gas for said cylinder.

9. A scale for calculating a remaining time that gas remains in a cylinder, the scale comprising:
a hook to hang the cylinder;
analog to digital circuitry coupled to the hook;
circuitry for inputting a weight of said cylinder when empty;
circuitry, coupled to said analog to digital circuitry, for calculating a total weight of said cylinder when it contains said gas;
circuitry for calculating an actual tare weight of said gas in said cylinder using said total weight of said cylinder when it contains said gas and said weight of said cylinder when empty; and
circuitry for calculating said remaining time said gas remains in said cylinder using a flow rate of said gas and said actual tare weight of said gas in said cylinder.

10. The scale as recited in claim 9, wherein said actual tare weight of said gas in said gas cylinder is equal to said total weight of said cylinder with said gas minus said weight of said cylinder when empty.

11. The scale as recited in claim 9 further comprising:
circuitry for receiving said flow rate of said gas from a flow meter.

12. The scale as recited in claim 9 further comprising:
circuitry for calculating said flow rate of said gas using an amount of tare weight said gas declined and a time it took for said tare weight of said gas to decline to said amount.

13. The scale as recited in claim 9, further comprising a display for displaying said actual tare weight.

14. The scale as recited in claim 9 further comprising a display for displaying said remaining time.

15. A scale, comprising:
a hook for hanging a gas cylinder;
a memory unit for storing a computer program operable for calculating a remaining time that gas remains in the cylinder;
a processor coupled to said memory unit and said hook, wherein said processor, responsive to said computer program, comprises:
circuitry for receiving a weight of said cylinder when empty;
circuitry for calculating a total weight of said cylinder with said gas;
circuitry for calculating an actual tare weight of said gas in said cylinder using said total weight of said cylinder with said gas and said weight of said cylinder when empty; and
circuitry for calculating said remaining time said gas remains in said cylinder using a flow rate of said gas and said actual tare weight of said gas in said cylinder.

16. The system as recited in claim 15, wherein said actual tare weight of said gas in said cylinder is equal to said total weight of said cylinder with said gas minus said weight of said cylinder when empty.

17. The system as recited in claim 15, wherein said processor further comprises:
circuitry for calculating said flow rate of said gas using an amount of tare weight said gas declined and a time it took for said tare weight of said gas to decline to said amount.

18. The system as recited in claim 15, wherein said remaining time said gas remains in said cylinder is calculated by said actual tare weight of said gas in said cylinder divided by said flow rate of said gas.

19. The system as recited in claim 15, wherein said processor further comprises:
circuitry for receiving a maximum tare weight of said gas for said cylinder; and
circuitry for calculating a percentage of said actual tare weight of said gas in said cylinder to said maximum tare weight of said gas for said cylinder.
